(19) United States
(12) Patent Application Publication
(10) Pub. No.: US 2017/0004575 A1
(43) Pub. Date: Jan. 5, 2017

(54) DISSEMINATION OF ORDER STATUS INFORMATION PRESENT ON AN ELECTRONIC EXCHANGE

(71) Applicant: Chicago Mercantile Exchange Inc., Chicago, IL (US)

(72) Inventors: Manik Repaka, Gillette, NJ (US); James Bradley, Chicago, IL (US); Baris Mestanogullari, Chicago, IL (US); Dan Judson, Chicago, IL (US); Paul Bauerschmidt, Chicago, IL (US); Russell Karas, Chicago, IL (US); Carrick Pierce, Chicago, IL (US); Yu Sang Kwan, Chicago, IL (US)

(21) Appl. No.: 14/789,527

(22) Filed: Jul. 1, 2015

(51) Int. Cl. G06Q 40/04; H04L 12/58

(52) U.S. Cl. CPC G06Q 40/04; H04L 51/04

(57) ABSTRACT

The disclosed embodiments relate to facilitating the dissemination of order status information to market participants from an Exchange. According to one or more disclosed embodiments, a system or method is provided for monitoring one or more thinly traded products and/or markets and converting the exchange-based order information of a given product or market into instant messages to market participants. When the status of one or more monitored products or markets changes, an instant message is generated reflecting those changes in the market. The instant messages are disseminated to all market participants who have registered interest in the monitored product.

### BACKGROUND

A financial instrument trading system, such as a futures exchange, referred to herein also as an “Exchange”, such as the Chicago Mercantile Exchange Inc. (CME), provides a contract market where financial instruments, for example futures and options on futures, are traded. Futures is a term used to designate all contracts for the purchase or sale of financial instruments or physical commodities for future delivery or cash settlement on a commodity futures exchange. A futures contract is a legally binding agreement to buy or sell a commodity at a specified price at a predetermined future time. An option is the right, but not the obligation, to sell or buy the underlying instrument (in this case, a futures contract) at a specified price within a specified time. The commodity to be delivered in fulfillment of the contract, or alternatively the commodity for which the cash market price shall determine the final settlement price of the futures contract, is known as the contract's underlying reference or “underlier.” The terms and conditions of each futures contract are standardized as to the specification of the contract's underlying reference commodity, the quality of such commodity, quantity, delivery date, and means of contract settlement. Cash Settlement is a method of settling a futures contract whereby the parties effect final settlement when the contract expires by paying/receiving the loss/gain related to the contract in cash, rather than by effecting physical sale and purchase of the underlying reference commodity at a price determined by the futures contract, price.

Typically, the Exchange provides for a centralized “clearing house” through which all trades made must be confirmed, matched, and settled each day until offset or delivered. The clearing house is an adjunct to the Exchange, and may be an operating division of the Exchange, which is responsible for settling trading accounts, clearing trades, collecting and maintaining performance bond funds, regulating delivery, and reporting trading data. The essential role of the clearing house is to mitigate credit risk. Clearing is the procedure through which the Clearing House becomes buyer to each seller of a futures contract, and seller to each buyer, also referred to as a novation, and assumes responsibility for protecting buyers and sellers from financial loss due to breach of contract, by assuring performance on each contract. A clearing member is a firm qualified to clear trades through the Clearing House.

Current financial instrument trading systems allow traders to submit orders and receive confirmations, market data, and other information electronically via a network. These “electronic” marketplaces are an alternative to pit based trading systems whereby the traders, or their representatives, all physically stand in a designated location, i.e. a trading pit, and trade with each other via oral and hand based communication. Anyone standing in or near the trading pit may be privy to the trades taking place, i.e. who is trading, what they are offering to trade (price and quantity), and what ultimately trades. Electronic trading systems attempt to replicate the trading pit environment in a marketplace of electronic form. In doing so, electronic trading systems ideally offer an efficient, fair and balanced market where market prices reflect a true consensus of the value of traded products among the market participants, where the intentional or unintentional influence of any one market participant is minimized if not eliminated, and where unfair or inequitable advantages with respect to information access are minimized if not eliminated.

One manner in which electronic marketplaces attempt to achieve these goals is by equitably providing access to public market information, such as by efficiently disseminating public data, e.g. market data, prices, etc. or changes thereto, to all market participants. As new products are added to an Exchange and existing products are traded, many products may be thinly traded or not traded at all. The Exchange has a strong interest in promoting awareness of activity in nascent markets in order to encourage additional activity and achieving growth of those markets. Awareness of activity in nascent markets by market participants in “electronic” marketplaces is difficult due to constraints on the amount of, and media by which, information may be provided to participants (e.g., due to communications bandwidth constraints), the limited display screen space used to monitor thousands of products listed on the Exchange, etc.

### BRIEF DESCRIPTION OF THE DRAWINGS

FIG. 1 depicts an illustrative computer network system that may be used to implement aspects of the disclosed embodiments.

FIG. 2 depicts a block diagram of an exemplary implementation of the system of FIG. 1 for facilitating the dissemination of order status information.

FIG. 3 depicts a flow chart showing operation of the system of FIGS. 1 and 2.

FIG. 4 shows an illustrative embodiment of a general computer system for use with the system of FIGS. 1 and 2.

FIG. 5 depicts an exemplary embodiment for facilitating the dissemination of order status information.

FIG. 6 depicts an exemplary message used with a disclosed embodiment.

### DETAILED DESCRIPTION

The disclosed embodiments relate to facilitating the dissemination of order status information to market participants from an Exchange, such as the Chicago Mercantile Exchange (“CME”). According to one or more disclosed embodiments, a system or method is provided for monitoring one or more thinly traded products and/or markets and converting the exchange-based order information of a given product or market into messages (e.g., instant messages) to market participants. When the status of one or more monitored products or markets changes, an instant message may be generated reflecting those changes in the market. The instant messages may be disseminated to all, or a subset of, market participants who have registered interest in the monitored product.

One or more of the disclosed embodiments may improve existing systems and methods for monitoring new or existing products, such as in thinly traded markets, in an “electronic” marketplace and informing market participants when there is interest in one or more thinly traded markets. The disclosed systems and methods may provide an Exchange with an efficient way to facilitate the dissemination of information for multiple markets in a manner that supports the market participants' current workflow and in a manner that minimizes consumption of the participant's computational resources (e.g., does not take their desktop real estate), such as by leveraging the existing instant messaging based applications on the market makers' computer system user interfaces (e.g., desktops).

One or more of the disclosed embodiments may also result in more quote activity by market participants in an Exchange, narrower bid-ask widths and accurate price discovery by facilitating the monitoring a multitude of products and/or markets and by notifying a large distribution list of market participants.

One or more of the disclosed embodiments may also reduce the amount of information that must be communicated to the market participant and may also reduce distractions to one or more market participants, thereby improving efficiency and reducing errors. For example, in a live environment, such as a trading pit, market participants are able to observe market conditions by perceiving, consuming and synthesizing large volumes of information via multiple high bandwidth communications channels (i.e., by receiving information in the trading pit by monitoring numerous computer displays, listening to other traders, observing market activity and volume, etc.). Further, in such a live environment, the ability to discriminate between relevant and superfluous information may be enhanced by the market participant's immersion therein. However, in an electronic trading environment, the flow of information may be funneled through or otherwise constrained by the information channels available via the market participant's electronic device (i.e., a computer, mobile phone, etc.), which may significantly impede the market participant's ability to monitor market conditions. In other words, as opposed to the trading pit wherein the participant is exposed to or otherwise immersed in multiple information sources which surround the participant, in an electronic trading environment, all information is channeled or otherwise flows to the participant via a singular medium (i.e., the interface of their electronic trading terminal), focusing and compacting that flow of information. Further, the information channels available in an electronic trading environment may also limit the uptake of information and/or limit the ability to discriminate among various information sources. These problems may be exacerbated in a fast moving market. Accordingly, while electronic trading systems may provide significant benefits (e.g., with respect to trading efficiency, information access, data analysis, etc.), such electronic trading systems may detract from the participant's ability to observe market conditions and to perceive and process large amounts of information provided via a variety of independent communication channels. One or more of the disclosed embodiments may mitigate or eliminate this problem by off-loading the need to observe various market conditions, such as activity in a thinly traded market, thereby reducing the amount of information that must be consumed, and further reducing distractions. Thus, by automating the monitoring various market conditions and only alerting the market participant when necessary (e.g., when a market condition changes), a market participant may focus more attention on other matters.

It will be appreciated that the messages described herein may be received simultaneously by market participants, or temporally so close together as to be considered or perceived as being simultaneously received, for example, the difference in their time of receipt is too close to measure or otherwise discriminate among, also referred to as “substantially simultaneously.” Accordingly, the message timing may be implementation dependent and may depend on the implemented degree to which time of receipt of a transaction may be measured by the receiver (e.g., based on the implemented number of decimal place or number of bits used to delineate time of receipt) and/or the implemented network collision handling mechanisms which arbitrate among multiple transactions (e.g., data packets, headers or the signals indicative thereof, received within a defined time window).

While the disclosed embodiments may be discussed in relation to communications of financial related messages among participants in an electronic trading system, it will be appreciated that the disclosed embodiments may be used for communications among participants which consolidate public and private components in a publicly distributed message. For example, where multiple requestors make requests from a system but each wishes to remain anonymous among all of the other requestors, the system may respond to those requests with a single broadcast message to all of the requestors indicating the status of each request rather than individual response messages. The disclosed embodiments may facilitate such a broadcast message allowing each requestor to know the status of their own request without being able to associate the remaining request statuses with any of the other requestors. Accordingly, with respect to the disclosed electronic trading system embodiment, the term “participant” may refer to a trader, clearing member, market participant, or other user of an electronic trading system and the term “message” may refer to request messages such as orders to trade (e.g., buy or sell), a financial product, requests to modify or cancel previous orders, as well as the response messages thereto, as will be described. However, it will be appreciated that a participant may be any user of a communications system, or may refer to a device used by such as user, and a message, whether requests or responses thereto, may be for any purpose, as described herein.

Further, while the disclosed embodiments may be discussed in relation to futures and/or options on futures trading, it will be appreciated that the disclosed embodiments may be applicable to any equity, options or futures trading system or market now available or later developed. It will be appreciated that a trading environment, such as a futures exchange as described herein, implements one or more economic markets where rights and obligations may be traded. As such, a trading environment may be characterized by a need to maintain market integrity, transparency, predictability, fair/equitable access and participant expectations with respect thereto. For example, an exchange must respond to inputs, such as trader orders, cancellation, etc., in a manner as expected by the market participants, such as based on market data (e.g., prices), available counter-orders, etc., to provide an expected level of certainty that transactions will occur in a consistent and predictable manner. In addition, it will be appreciated that electronic trading systems further impose additional expectations and demands by market participants as to transaction processing speed, latency, capacity and response time, while creating additional complexities relating thereto. Accordingly, as will be described, the disclosed embodiments may further include functionality to ensure that the expectations of market participant are met (e.g., that predictable system responses are maintained).

As used herein, a financial message refers both to messages communicated by market participants to an electronic trading system and vice versa. Financial messages communicated to the electronic trading system, also referred to as “inbound” messages, may include request or order messages, such as trader orders, order modifications, order cancellations and the like, as well as other message types. Financial messages communicated from the electronic trading system, referred to as “outbound” messages, may include messages responsive to inbound messages, such as confirmation or acknowledgment messages, or other messages such as market update messages, quote messages, and the like, such as the alert messages discussed below.

Financial messages may further be categorized as having or reflecting an impact on a market or electronic marketplace, also referred to as an “order book” or “book,” for a traded product, such as a prevailing price therefore, number of resting orders at various price levels and quantities thereof, etc., or not having or reflecting an impact on a market or a subset or portion thereof. For example a request to place a trade may result in a response indicative of the trade either being matched with, or being rested on an order book to await, a suitable counter-order. This response may include a message directed solely to the trader who submitted to the order to acknowledge receipt of the order and report whether it was matched, and the extent thereto, or rested. The response may further include a message to all market participants reporting a change in the order book due to the order. This response may take the form of a report of the specific change to the order book, e.g. an order for quantity X at price Y was added to the book (referred to as a Market By Order message), or may simply report the result, e.g. price level Y is now has 5 orders for a total quantity if Z (where Z is the sum of the previous resting quantity plus quantity X of the new order) (referred to as a Market By Price message). In some cases, requests may elicit a non-impacting response, such as temporally proximate to the receipt of the request and then cause a separate market-impact reflecting response at a later time. For example, a stop order, fill or kill order, aka an immediate or cancel order, or other conditional request may not have an immediate market impacting effect, if at all, until the requisite conditions are met. Accordingly, an acknowledgement or confirmation of receipt (e.g., a non-market impacting communication) may be sent to the trader simply confirming that the order was received. Upon the conditions being met and a market impacting result thereof occurring, a market-impacting message may be transmitted as described herein both directly back to the submitting market participant and to all market participants (in a Market By Price “MBP” or Market By Order “MBO” format). It will be appreciated that additional conditions may be specified, such as a time or price limit, which may cause the order to be dropped or otherwise canceled and that such an event may result in another non-market-impacting communication instead. As will be described below, in some implementations market impacting communications may be communicated separately from non-market impacting communications, such as via a separate communications channel or feed. It will be further appreciated that various types of market data feeds may be provided which reflect different market or aspects thereof. Market participants may then, for example, subscribe to receive those feeds of interest to them. As market impacting communications tend to be more important to market participants then non impacting communications, this separation may reduce congestion and/or noise among those communications having or reflecting an impact on a market or portion thereof. Furthermore, a particular market data feed may only communicate information related to the top buy/sell prices for a particular product, referred to as “top of book” feed, e.g. only changes to the top 10 price levels are communicated. Such limitations may be implemented to reduce consumption of bandwidth and message generation resources. In this case, while a request message may be considered market-impacting if it affects a price level other than the top buy/sell prices, it will not result in a message being sent to the market participants. Generally, the disclosed embodiments may be used in conjunction with a restructuring of response messages reflecting market impacting events to reduce redundant data and convey more relevant information about the event to all market participants sooner than less relevant information so that the market participants may comprehend the event more quickly. Furthermore, the disclosed embodiments may be used in conjunction with consolidation of the communication of market impact reflecting response messages (e.g., responsive to inbound messages) with other market impact reflecting messages as will be described. In other implementations, these communications may or may not be further consolidated with non-market impacting messages.

Examples of the various types of market data feeds which may be provided by electronic trading systems, such as the CME, in order to provide different types or subsets of market information or to provide such information in different formats include Market By Order, Market Depth (a.k.a., Market by Price to a designated depth of the book) (e.g., CME offers a 10-deep market by price feed), Top of Book (a single depth Market by Price feed), and combinations thereof. There may also be all manner of specialized feeds in terms of the content (i.e., providing, for example, derived data, such as a calculated index). Market data feeds may be characterized as providing a “view” or “overview” of a given market, an aggregation or a portion thereof or changes thereto. For example, a market data feed, referred to as a Market By Price (“MBP”) feed, may convey, with each message, the entire/current state of a market, or portion thereof, for a particular product as a result of one or more market impacting events. For example, an MBP message may convey a total quantity of resting buy/sell orders at a particular price level in response to a new order being placed at that price. An MBP message may convey a quantity of an instrument which was traded in response to an incoming order being matched with one or more resting orders. MBP messages may only be generated for events affecting a portion of a market (e.g., only the top 10 resting buy/sell orders), and thereby, only provide a view of that portion. As used herein, a market impacting request may be said to impact the “view” of the market as presented via the market data feed. An MBP feed may utilize different message formats for conveying different types of market impacting events. For example, when a new order is rested on the order book, an MBP message may reflect the current state of the price level to which the order was added (e.g., the new aggregate quantity and the new aggregate number of resting orders). As can be seen, such a message conveys no information about the resting orders, including the newly rested order, themselves to the market participants. Only the submitting market participant, who receives a separate private message acknowledging the event, knows that it was their order that was added to the book. Similarly, when a trade occurs, an MBP message may be sent which conveys the price at which the instrument was traded, the quantity traded and the number of participating orders, but may convey no information as to whose particular orders contributed to the trade. MBP feeds may further batch reporting of multiple events, i.e. report the result of multiple market impacting events in a single message.

Alternatively, a market data feed, referred to as a Market By Order (“MBO”) feed, may convey data reflecting a change that occurred to the order book rather than the result of that change (e.g., that order ABC for quantity X was added to price level Y or that order ABC and order XYZ traded a quantity X at a price Y). In this case, the MBO message identifies only the change that occurred so a market participant wishing to know the current state of the order book must maintain their own copy and apply the change reflected in the message to know the current state. As can be seen, MBO messages carry much more data because they reflect any market impacting change. Furthermore, because specific orders, but not the submitting traders thereof, are identified, other market participants may be able to follow that order as it progresses through the market (e.g., as it is modified, canceled, traded, etc.).

It will be appreciated that number, type and manner of market data feeds provided by an electronic trading system are implementation dependent and may vary depending upon the types of products traded by the electronic trading system, customer/trader preferences, bandwidth and data processing limitations, etc. and that all such feeds, now available or later developed, are contemplated herein. As such, MBP and MBO feeds may refer to categories/variations of market data feeds, distinguished by whether they provide an indication of the current state of a market resulting from a market impacting event (MBP) or an indication of the change in the current state of a market due to a market impacting event (MBO).

Messages, whether MBO or MBP, generated responsive to market impacting events which are caused by a single order, such as a new order, an order cancelation, an order modification, etc., are fairly simple and compact and easily created and transmitted. However, messages, whether MBO or MBP, generated response to market impacting events which are caused by more than one order, such as a trade, may require the transmission of a significant amount of data to convey the requisite information to the market participants. For trades involving a large number of orders (e.g., a buy order for a quantity of 5000 which matches 5000 sell orders each for a quantity of 1), a significant amount of information may need to be sent (e.g., data indicative of each of the 5000 trades that have participated in the market impacting event).

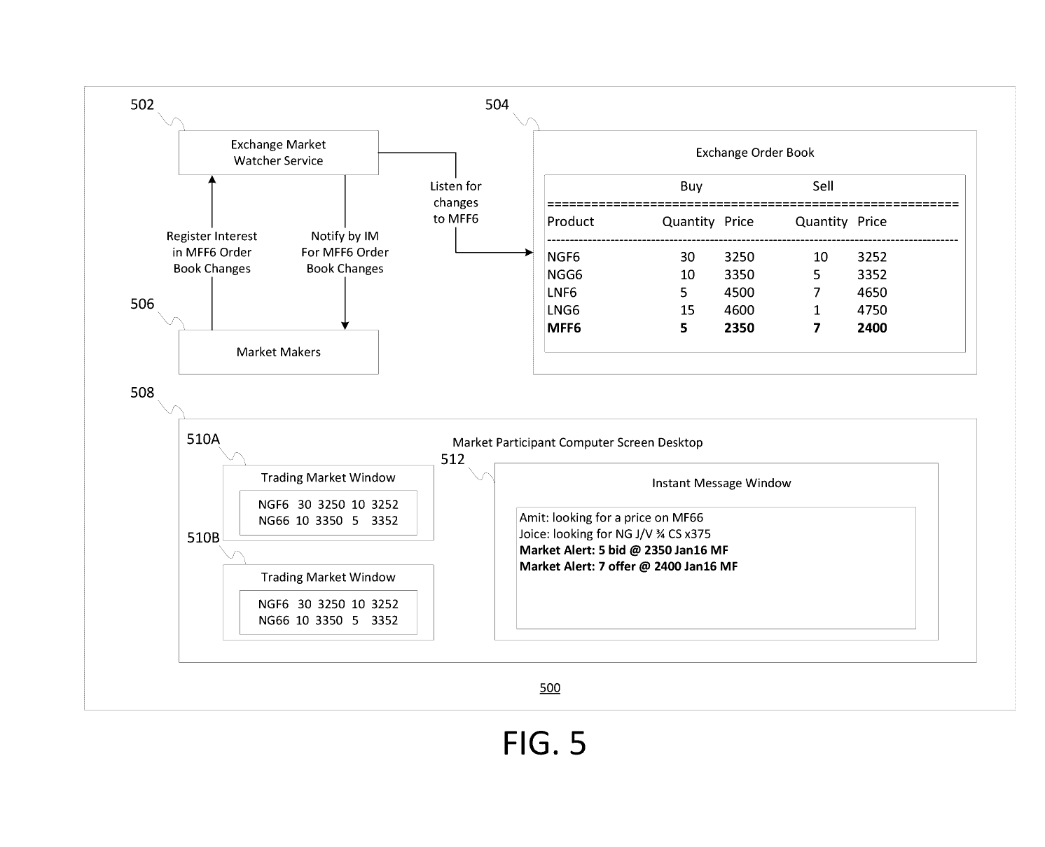

Referring to FIG. 5, an exemplary embodiment for facilitating the dissemination of order status information is provided. The system 500 includes an exchange market watcher service 502, an exchange order book 504, one or more market makers 506, and a market participant computer screen desktop 508. The market participant computer screen desktop 508 includes one or more trading market windows 510A and 510B, and an instant message windows 512. Additional, different, or fewer components may be provided.

The exchange market watcher service 502 monitors the exchange order book 504 for changes in the status of one or more products and/or markets. The exchange market watcher service 502 is part of another component of a trading network environment, such as the transaction processing system. In this embodiment, the transaction processing system (e.g., the match engine) is thus improved by providing alerts to market participants about status changes for the monitored product. Alternatively, according to another embodiment, the exchange market watcher service 502 is a standalone system that monitors the exchange order book 502 through access to the trading network environment. For example, the exchange market watcher service is implemented with a computer program that electronically monitors the exchange order book 504. Market makers 506 register interest in receiving order update information in the form of instant message for products that the market maker 506 is interested in. For example, a market maker 506 may register by “opting-in” (e.g., signing up for alerts via a web based interface, or via telephone, mailing, etc.). In another example, a business line manager (BLM) may register users based on a market maker's expressed interested in a new or existing product or market (e.g., by developing relationships with market makers and through relationship management). In yet another example, a market maker 506 may be automatically registered for alerts (e.g., after requesting information about or searching for new or existing products or markets). Additional, different, or fewer registration methodologies may be provided.

One or more market makers 506 register with the exchange market watcher service 502 to monitor certain conditions for one or more products and/or markets. A market maker 506 is any user of an electronic trading system, such as market participants, market makers, traders, clearing members, and other users. The market makers 506 are interested in changes in the status of one or more products and/or markets represented in the exchange order book 502.

The exchange order book 504 includes the current bid and offer prices to enter a transaction for various products and/or markets. For example, exchange order book 504 includes the current buy and sell prices and quantities for a futures market. Referring to FIG. 5, the exchange order book 504 includes product designations (e.g., NGF6, NGG6, LNF6, LNG6 and MFF6), a buy quantity for each product designation (e.g., 30, 10, 5, 15 and 5, respectively), a buy price for each product designation (e.g., 3250, 3350, 4500, 4600 and 2350, respectively), a sell quantity for each product designation (e.g., 10, 5, 7, 1 and 7, respectively) and a sell price for each product designation (e.g., 3252, 3352, 4650, 4750 and 2400, respectively). When a new bid or offer transaction is entered by a market participant, the unsatisfied transaction will be entered on the exchange order book 504. For example, a market participant enters a bid to buy a new product (e.g., designated by MFF6) at a quantity of 5 contracts for $2,350 per contract. Further, another market participant enters a bid to sell the new product MFF6 at a quantity of 7 contracts for $2,400 per contract.

The market makers 506 may be interested in thinly traded markets. Thinly traded markets may be markets for products with low market activity (e.g., less than a threshold number of bids and offers, such as five (5) bids and five (5) offers), with low market volume (e.g., less than a threshold number of total contracts to buy and sell, such as ten (10) contracts to buy and ten (10) contracts to sell), and/or with existing unsatisfied orders that have sat on the market for a long period of time (e.g., such as a day, week, month, year, etc. depending on the market). For example, a thinly traded market may be a market for a product that cannot be easily sold or traded due to a limited number of interested buyers and/or sellers, or may require a substantial change in price to satisfy a transaction between interested buyers and sellers. In this example, there may not be any interested buyers and/or sellers, or less than a threshold number of interested buyers and/or sellers. Further, thinly traded markets may be markets for new products that have not been traded yet or have not gained sufficient traction in the market (e.g., less than a threshold number of total bids and offers, such as one hundred (100) offers, or less than a threshold number of satisfied transactions, such as one hundred (100) trades per day, week, month, year, etc.). For example, the new or existing product MFF6 is a thinly traded product. In this example, the market makers 506 register with the exchange market watcher service 502 to receive changes in the status of the new or existing product MFF6 in the exchange order book 504.

In one embodiment, the product MFF6 is a new product on the Exchange that has yet to be traded, or is rarely traded, because it has not gained traction in the market. In this embodiment, the market makers 506 are interested in any transactions for the new product MFF6. The exchange market watcher service 502 monitors the exchange order book 504 for any transactions entered for the new product MFF6 and notifies the market makers 506 of transactions. According to the registration preferences of the market maker 506, the market maker 506 may continue to receive notifications of all transactions for the new product MFF6, or may limit the number of notification by capping total number of notifications based on the number of transactions (e.g., provide notifications for each transaction up to a threshold number of transactions) or by throttling the number of notifications (e.g., provide notifications for transactions at a specified strike price, transactions during a specified time frame, etc.). In another example, the market makers 506 may be interested in receiving notifications for satisfied transactions.

In another embodiment, the product MFF6 is a new or existing product on the Exchange. In this embodiment, the market makers 506 are interested monitoring the rate of transactions for the product MFF6. For example, the rate of transactions can be measured by the activity in the market (e.g., how many transactions are entered), by the market volume (e.g., how many contracts are entered), or a combination thereof. The activity and volume of transactions can be indicative of preferred market conditions. For example, a high level activity in a market of participation with low volume (e.g., many transactions for low quantities) may be preferred to low activity with high volume (e.g., few transactions for large quantities), and vice versa. In this embodiment, the market makers 506 register with the exchange market watcher service 502 to monitor the rate of transactions being entered on the exchange order book 504 (e.g., activity and/or volume is increasing/accelerating, decreasing/decelerating, or there is no activity). In another example, the market makers 506 may only be interested in receiving notifications for the rate of satisfied transactions.

In yet another embodiment, the market makers 506 are interested monitoring other market conditions for the product MFF6, such as bid-offer width, sufficient or insufficient market depth, volume weighted average price (VWAP), etc. For example, the market makers 506 may be interested in the bid-offer width, such as when the difference between a transaction to buy a product and a transaction to sell the product is a less than a threshold amount. In another example, the market makers 506 may be interested in the market depth, such as when an incoming transaction changes the price of the product by more or less than a threshold amount. Additional and different market conditions may be monitored.

In an embodiment, a plurality of market makers 506 are interested in monitoring market conditions for a plurality of non-overlapping products. For, example, one market maker registers for alerts for products NGF6, NGG6 and LNG6, and a second market maker registers for alerts for products LNF6 and MFF6. In this example, the market watcher service 502 maintains a data structure for storing the various market maker registrations, and monitors the exchange order book 504 for changes in the market conditions for the registered products. When the market conditions for a registered product changes, the market watcher service 502 cross-references the data structure and provides alerts to the market makers 506 that registered for alerts for the registered product. In another example, the two market makers 506 register for alerts based on different market conditions for the same product MFF6 (e.g., different market volume or activity thresholds, etc.). Additional and different combinations of market makers, monitored products and market conditions may be monitored.

The market participant computer screen desktop 508 provides a market maker 506 with one or more trading market windows 510A and 510B, and an instant message windows 512. Market makers 506 monitor exchanged based electronic market activity using the market participant computer screen desktop 508. For example, the market makers 506 can choose to monitor specific products using one or more trading market windows 510A and 510B. The market makers 506 also use instant messaging for communicating over-the-counter order flow via instant message window 512. Market makers 506 communicate with other market participants using instant messaging applications. The instant messaging applications facilitate communication between multiple market participants (e.g., instant message contacts or “buddies”) using the limited desktop space efficiently. Instant messages will then be sent to a chat room and/or through one or more instant messaging platforms to a distribution list of interested traders.

In an embodiment, the exchange market watcher service 502 leverages the existing instant messaging based applications and instant message windows 512 on the market participant computer screen desktops 508 to provide notifications of market conditions. In this example, a market alert is provided when a bid for 5 contracts of the new product MFF6 at $2,350 for each contract. Similarly, a market alert is provided when an offer for 7 contracts of the new product MFF6 at $2,400 for each contract.

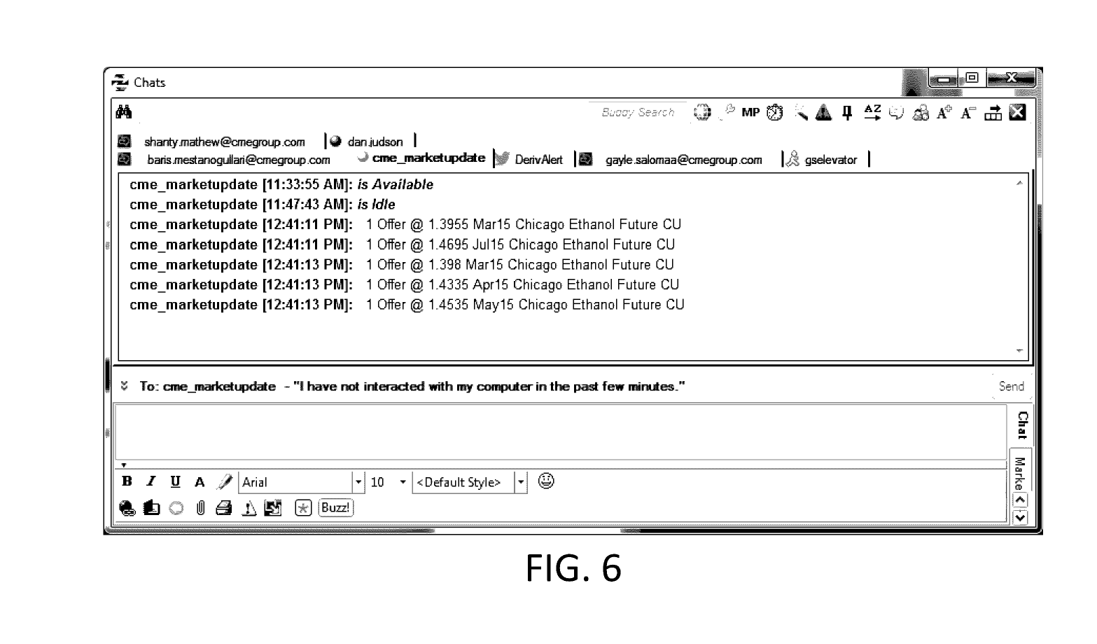

Referring to FIG. 6, an exemplary instant message used in another disclosed embodiment is depicted. In this example, a market participant has an instant message contact for the exchange market watcher service 502 (e.g., “cme_marketupdate”). Messages from the instant message contact may be displayed in a chat room, or in a separate tab for the contact. Further, in this example, when an offer to enter a transaction for a new product (e.g., “Chicago Ethanol Future CU”) is entered into the market order book 504, the market participant is notified (e.g., “1 Offer @ 1.3955 Mar15 Chicago Ethanol Future CU”). In this example, the type of transaction (e.g., bid or offer), the quantity of the transaction (e.g., how many contracts), the price per contract, the date and the product designation is provided. Additional, different, or less information may be provided.

In additional embodiments, notifications may be provided by the exchange market watcher service 502 to market makers 506 via electronic mail (email), mobile phone text messaging, automated telephone calls, “tweets” on Twitter®, etc. Additional and different notifications may be provided.

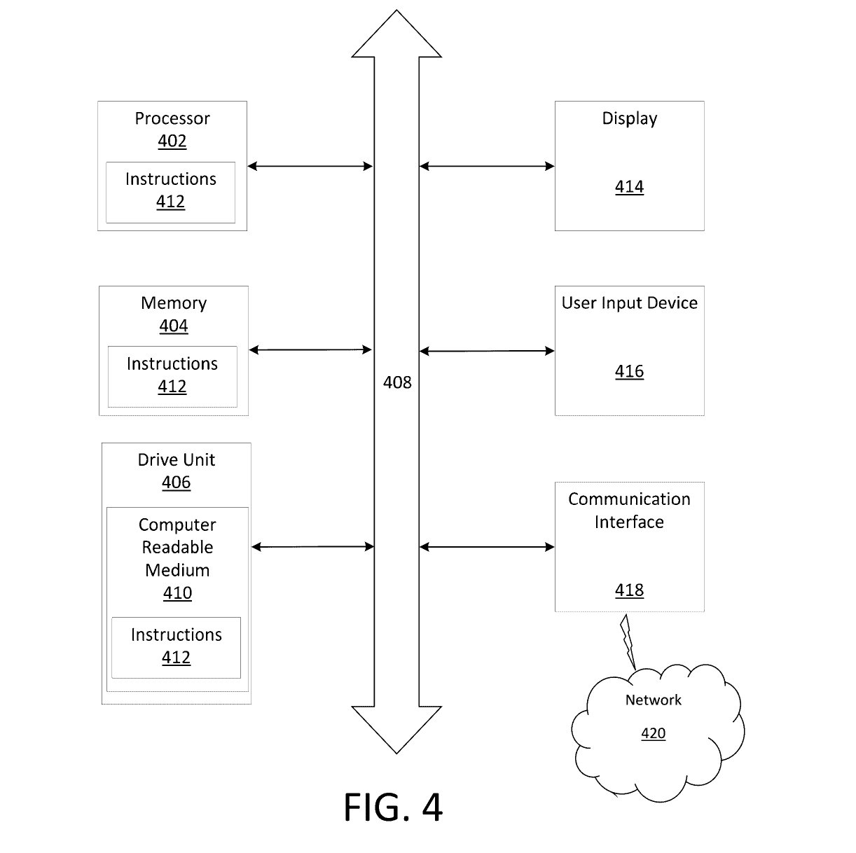

Referring to FIG. 4, an illustrative embodiment of a general computer system 400 is shown. The computer system 400 can include a set of instructions that can be executed to cause the computer system 400 to perform any one or more of the methods or computer based functions disclosed herein. The computer system 400 may operate as a standalone device or may be connected (e.g., using a network, to other computer systems or peripheral devices). Any of the components discussed above, such as the processor 202, may be a computer system 400 or a component in the computer system 400. The computer system 400 may implement a match engine, margin processing, payment or clearing function on behalf of an exchange, such as the Chicago Mercantile Exchange, of which the disclosed embodiments are a component thereof.

In a networked deployment, the computer system 400 may operate in the capacity of a server or as a client user computer in a client-server user network environment, or as a peer computer system in a peer-to-peer (or distributed) network environment. The computer system 400 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 400 can be implemented using electronic devices that provide voice, video or data communication. Further, while a single computer system 400 is illustrated, the term “system” shall also be taken to include any collection of systems or sub-systems that individually or jointly execute a set, or multiple sets, of instructions to perform one or more computer functions.

As illustrated in FIG. 4, the computer system 400 may include a processor 402 (e.g., a central processing unit (CPU)), a graphics processing unit (GPU), or both. The processor 402 may be a component in a variety of systems. For example, the processor 402 may be part of a standard personal computer or a workstation. The processor 402 may be one or more general processors, digital signal processors, application specific integrated circuits, field programmable gate arrays, servers, networks, digital circuits, analog circuits, combinations thereof, or other now known or later developed devices for analyzing and processing data. The processor 402 may implement a software program, such as code generated manually (i.e., programmed).

The computer system 400 may include a memory 404 that can communicate via a bus 408. The memory 404 may be a main memory, a static memory, or a dynamic memory. The memory 404 may include, but is not limited to computer readable storage media such as various types of volatile and non-volatile storage media, including but not limited to random access memory, read-only memory, programmable read-only memory, electrically programmable read-only memory, electrically erasable read-only memory, content addressable memory, flash memory, magnetic tape or disk, optical media and the like. In one embodiment, the memory 404 includes a cache or random access memory for the processor 402. In alternative embodiments, the memory 404 is separate from the processor 402, such as a cache memory of a processor, the system memory, or other memory. The memory 404 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 404 is operable to store instructions executable by the processor 402. The functions, acts or tasks illustrated in the figures or described herein may be performed by the programmed processor 402 executing the instructions 412 stored in the memory 404. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 400 may further include a display unit 414, such as a liquid crystal display (LCD), an organic light emitting diode (OLED), a flat panel display, a solid state display, a cathode ray tube (CRT), a projector, a printer or other now known or later developed display device for outputting determined information. The display 414 may act as an interface for the user to see the functioning of the processor 402, or specifically as an interface with the software stored in the memory 404 or in the drive unit 406.

Additionally, the computer system 400 may include an input device 416 configured to allow a user to interact with any of the components of system 400. The input device 416 may be a number pad, a keyboard, or a cursor control device, such as a mouse, or a joystick, touch screen display, remote control or any other device operative to interact with the system 400.

In a particular embodiment, as depicted in FIG. 4, the computer system 400 may also include a disk or optical drive unit 406. The disk drive unit 406 may include a computer-readable medium 410 in which one or more sets of instructions 412 (e.g., software), can be embedded. Further, the instructions 412 may embody one or more of the methods or logic as described herein. In a particular embodiment, the instructions 412 may reside completely, or at least partially, within the memory 404 and/or within the processor 402 during execution by the computer system 400. The memory 404 and the processor 402 also may include computer-readable media as discussed above.

The present disclosure contemplates a computer-readable medium that includes instructions 412 or receives and executes instructions 412 responsive to a propagated signal, so that a device connected to a network 420 can communicate voice, video, audio, images or any other data over the network 420. Further, the instructions 412 may be transmitted or received over the network 420 via a communication interface 418. The communication interface 418 may be a part of the processor 402 or may be a separate component. The communication interface 418 may be created in software or may be a physical connection in hardware. The communication interface 418 is configured to connect with a network 420, external media, the display 414, or any other components in system 400, or combinations thereof. The connection with the network 420 may be a physical connection, such as a wired Ethernet connection or may be established wirelessly as discussed below. Likewise, the additional connections with other components of the system 400 may be physical connections or may be established wirelessly.

The network 420 may include wired networks, wireless networks, or combinations thereof. The wireless network may be a cellular telephone network, an 802.11, 802.16, 802.20, or WiMax network. Further, the network 420 may be a public network, such as the Internet, a private network, such as an intranet, or combinations thereof, and may utilize a variety of networking protocols now available or later developed including, but not limited to TCP/IP based networking protocols.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products (i.e., one or more modules of computer program instructions encoded on a computer readable medium for execution by, or to control the operation of, data processing apparatus). While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein. The computer readable medium can be a machine-readable storage device, a machine-readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question (e.g., code that constitutes processor firmware, a protocol stack, a database management system, an operating system, or a combination of one or more of them).

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks (e.g., internal hard disks or removable disks); magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a device having a display (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback) or tactile feedback; and input from the user can be received in any form, including acoustic, speech, or tactile input.

Embodiments of the subject matter described in this specification can be implemented in a computing system that includes a back end component (e.g., as a data server), that includes a middleware component (e.g., an application server), that includes a front end component (e.g., a client computer having a graphical user interface or a Web browser through which a user can interact with an implementation of the subject matter described in this specification), or any combination of one or more such back end, middleware, or front end components. The components of the system can be interconnected by any form or medium of digital data communication (e.g., a communication network). Examples of communication networks include a local area network (“LAN”) and a wide area network (“WAN”) (e.g., the Internet).

The computing system can include clients and servers. A client and server are generally remote from each other and typically interact through a communication network. The relationship of client and server arises by virtue of computer programs running on the respective computers and having a client-server relationship to each other.

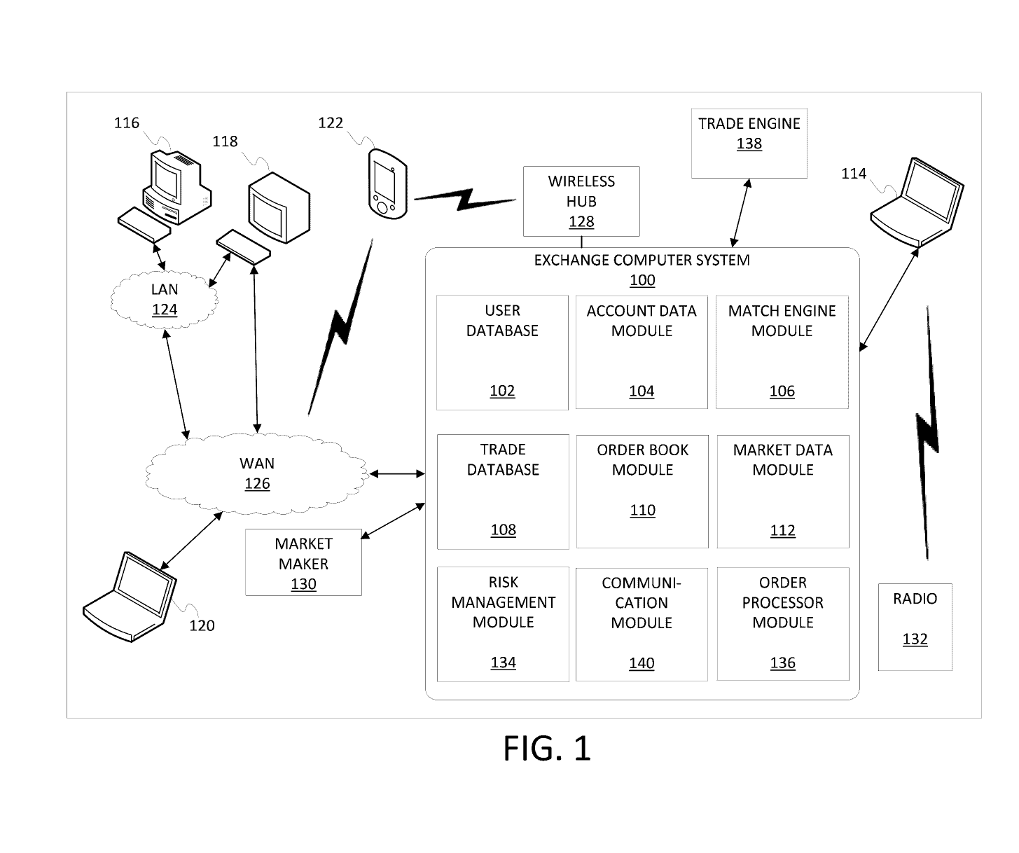

In accordance with aspects of the disclosure, systems and methods are disclosed for generating financial messages in accordance therewith The disclosed embodiments are preferably implemented with computer devices and computer networks, such as those described with respect FIG. 4, that allow users (e.g., market participants) to exchange trading information. It will be appreciated that the plurality of entities utilizing the disclosed embodiments (e.g., the market participants), may be referred to by other nomenclature reflecting the role that the particular entity is performing with respect to the disclosed embodiments and that a given entity may perform more than one role depending upon the implementation and the nature of the particular transaction being undertaken, as well as the entity's contractual and/or legal relationship with another market participant and/or the exchange. An exemplary trading network environment for implementing trading systems and methods is shown in FIG. 1. An exchange computer system 100 receives orders and transmits market data related to orders and trades to users, such as via wide area network 126 and/or local area network 124 and computer devices 114, 116, 118, 120 and 122, as will be described below, coupled with the exchange computer system 100. In one embodiment, the exchange computer system 100 may include a data transaction processing system in which data items are transacted by a hardware matching processor that matches electronic data transaction request messages for the same one of the data items based on multiple transaction parameters from different client computers over a data communication network.

Herein, the phrase “coupled with” is defined to mean directly connected to or indirectly connected through one or more intermediate components. Such intermediate components may include both hardware and software based components. Further, to clarify the use in the pending claims and to hereby provide notice to the public, the phrases “at least one of <A>, <B>, . . . and <N>” or “at least one of <A>, <B>, . . . <N>, or combinations thereof” are defined by the Applicants in the broadest sense, superseding any other implied definitions herebefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

The exchange computer system 100 may be implemented with one or more mainframe, desktop or other computers, such as the computer 400 described below with respect to FIGS. 1 and 4. A user database 102 may be provided which includes information identifying traders and other users of exchange computer system 100, such as account numbers or identifiers, user names and passwords. An account data module 104 may be provided which may process account information that may be used during trades. A match engine module 106 may be included to match bid and offer prices and may be implemented with software that executes one or more algorithms for matching bids and offers. A trade database 108 may be included to store information identifying trades and descriptions of trades. In particular, a trade database may store information identifying the time that a trade took place and the contract price. An order book module 110 may be included to compute or otherwise determine current bid and offer prices. A market data module 112 may be included to collect market data and prepare the data for transmission to users. A risk management module 134 may be included to compute and determine a user's risk utilization in relation to the user's defined risk thresholds. An order processing module 136 may be included to decompose delta based and bulk order types for processing by the order book module 110 and/or match engine module 106. A communication module 140 may be included to, among other things, control the rate of acceptance of mass quote messages in accordance with one or more aspects of the disclosed embodiments. It will be appreciated that concurrent processing limits may be defined by or imposed separately or in combination, as was described above, on one or more of the trading system components, including the user database 102, the account data module 104, the match engine module 106, the trade database 108, the order book module 110, the market data module 112, the risk management module 134, the order processing module 136, or other component of the exchange computer system 100.

The trading network environment shown in FIG. 1 includes exemplary computer devices 114, 116, 118, 120 and 122 which depict different exemplary methods or media by which a computer device may be coupled with the exchange computer system 100 or by which a user may communicate, e.g. send and receive, trade or other information therewith. It will be appreciated that the types of computer devices deployed by traders and the methods and media by which they communicate with the exchange computer system 100 is implementation dependent and may vary and that not all of the depicted computer devices and/or means/media of communication may be used and that other computer devices and/or means/media of communications, now available or later developed may be used. Each computer device, which may comprise a computer 400 described in more detail below with respect to FIG. 4, may include a central processor that controls the overall operation of the computer and a system bus that connects the central processor to one or more conventional components, such as a network card or modem. Each computer device may also include a variety of interface units and drives for reading and writing data or files and communicating with other computer devices and with the exchange computer system 100. Depending on the type of computer device, a user can interact with the computer with a keyboard, pointing device, microphone, pen device or other input device now available or later developed.

An exemplary computer device 114 is shown directly connected to exchange computer system 100, such as via a T1 line, a common local area network (LAN) or other wired and/or wireless medium for connecting computer devices, such as the network 420 shown in FIG. 4 and described below with respect thereto. The exemplary computer device 114 is further shown connected to a radio 132. The user of radio 132, which may include a cellular telephone, smart phone, or other wireless proprietary and/or non-proprietary device, may be a trader or exchange employee. The radio user may transmit orders or other information to the exemplary computer device 114 or a user thereof. The user of the exemplary computer device 114, or the exemplary computer device 114 alone and/or autonomously, may then transmit the trade or other information to the exchange computer system 100.

Exemplary computer devices 116 and 118 are coupled with a local area network (“LAN”) 124 which may be configured in one or more of the well-known LAN topologies, e.g. star, daisy chain, etc., and may use a variety of different protocols, such as Ethernet, TCP/IP, etc. The exemplary computer devices 116 and 118 may communicate with each other and with other computer and other devices which are coupled with the LAN 124. Computer and other devices may be coupled with the LAN 124 via twisted pair wires, coaxial cable, fiber optics or other wired or wireless media. As shown in FIG. 1, an exemplary wireless personal digital assistant device (“PDA”) 122, such as a mobile telephone, tablet based compute device, or other wireless device, may communicate with the LAN 124 and/or the Internet 126 via radio waves, such as via WiFi, Bluetooth and/or a cellular telephone based data communications protocol. PDA 122 may also communicate with exchange computer system 100 via a conventional wireless hub 128.

FIG. 1 also shows the LAN 124 coupled with a wide area network (“WAN”) 126 which may be comprised of one or more public or private wired or wireless networks. In one embodiment, the WAN 126 includes the Internet 126. The LAN 124 may include a router to connect LAN 124 to the Internet 126. Exemplary computer device 120 is shown coupled directly to the Internet 126, such as via a modem, DSL line, satellite dish or any other device for connecting a computer device to the Internet 126 via a service provider therefore as is known. LAN 124 and/or WAN 126 may be the same as the network 420 shown in FIG. 4 and described below with respect thereto.

As was described above, the users of the exchange computer system 100 may include one or more market makers 130 which may maintain a market by providing constant bid and offer prices for a derivative or security to the exchange computer system 100, such as via one of the exemplary computer devices depicted. The exchange computer system 100 may also exchange information with other trade engines, such as trade engine 138. One skilled in the art will appreciate that numerous additional computers and systems may be coupled to exchange computer system 100. Such computers and systems may include clearing, regulatory and fee systems.

The operations of computer devices and systems shown in FIG. 1 may be controlled by computer-executable instructions stored on a non-transitory computer-readable medium. For example, the exemplary computer device 116 may include computer-executable instructions for receiving order information from a user and transmitting that order information to exchange computer system 100. In another example, the exemplary computer device 118 may include computer-executable instructions for receiving market data from exchange computer system 100 and displaying that information to a user.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may include other components not shown and be connected by numerous alternative topologies.

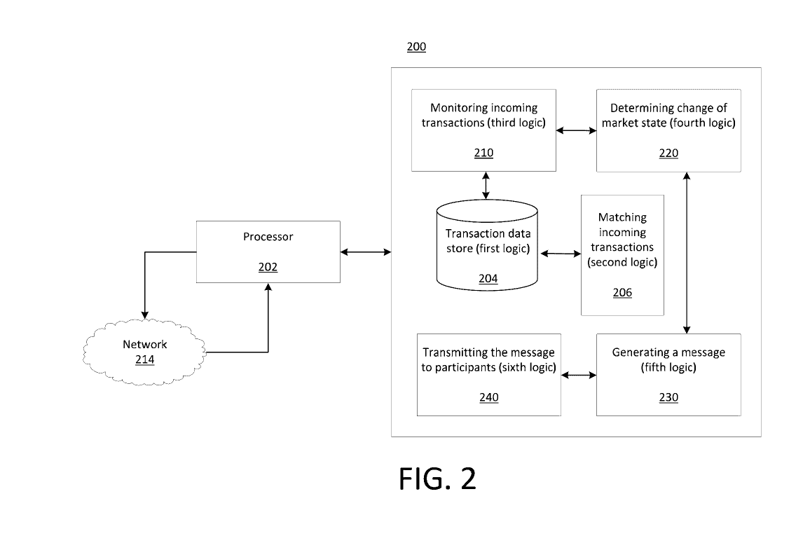

As shown in FIG. 1, the Exchange computer system 100 includes a market data module 112 which may implement the disclosed mechanisms as will be describe with reference to FIG. 2. However, as was discussed above, the disclosed mechanisms may be implemented at any logical and/or physical point(s) through which the relevant message traffic, and responses thereto, flows or is otherwise accessible, including one or more gateway devices, modems, the computers or terminals of one or more traders, etc.

FIG. 2 depicts a block diagram of a market data module 112 according to one embodiment, which in an exemplary implementation, is implemented as part of the exchange computer system 100 described above. As used herein, an exchange 100 includes a place or system that receives and/or executes orders. In particular, FIG. 2 shows a system 200 for providing market alerts to a plurality of market participants, such as via network 214. It will be appreciated that the disclosed embodiments may be applicable to other types of messages depending upon the implementation.

The system 200 for providing market alerts to a plurality of market participants via a network 214 includes a processor 202 and a memory 204 coupled therewith which may be implemented a processor 402 and memory 404 as described with respect to FIG. 4. The memory 204 includes a data structure 204, which may be as a separate memory component or as a first logic stored in the memory 204 operable to store one or more previously received but unsatisfied transactions. The system 200 includes a matching processor 206 that may be coupled with a data storage 204, which may be implemented as a separate hardware component or as a second logic stored in the memory 204 and executable by the processor 202 to cause the processor 202 to, upon receipt of an incoming transaction, to determine whether one or more previously received but unsatisfied transactions are stored in the data structure which are at least partially counter to the incoming transaction, and, based thereon, store any residual unsatisfied portion of the incoming order or the one or more previously received but unsatisfied orders in the data structure.

The system 200 further includes a monitoring processor 210, which may be implemented as a separate hardware component or as third logic 210 stored in the memory 204 and executable by the processor 202 to cause the processor 202 to monitor incoming transactions received by the match processor 206 (e.g., directly, or via the exchange order book or market data stream).

The system 200 further includes determining processor 220 which may be implemented as a separate hardware component or as forth logic 220 stored in the memory 204 and executable by the processor 202 to cause the processor 202 to determine when an incoming transaction for a monitored product is indicative of a change in the state of a market for the monitored product.

The system 200 further includes a message generation processor 230 which may be implemented as a separate hardware component or as fifth logic 230 stored in the memory 204 and executable by the processor 202 to cause the processor 202 to generate a message when it is determined that the incoming transaction for a monitored product changed the state of the market for the monitored product.

The system 200 further includes a message transmitter 240 which may be implemented as a separate hardware component or as sixth logic 240 stored in the memory 204 and executable by the processor 202 to cause the processor 202 to transmit the generated message to the subset of the plurality of participants.

In one embodiment, a computer implemented method is provided for releasing a data item having an alert for a transaction in a data transaction processing system in which data items are transacted by a hardware matching processor that matches electronic data transaction request messages for the same one of the data items based on multiple transaction parameters from different client computers over a data communication network. The method includes, prior to an initial processing by the hardware matching processor to process an electronic transaction request, monitoring by one or more hardware data processors whether the electronic transaction request is received by the hardware matching processor to process the electronic transaction request. Upon receipt of the electronic transaction request by the hardware matching processor, determining by one or more hardware data processors whether the electronic transaction request was received by the hardware matching processor. Upon determining that the electronic transaction request was received by the hardware matching processor, releasing the data item having an alert for the transaction.

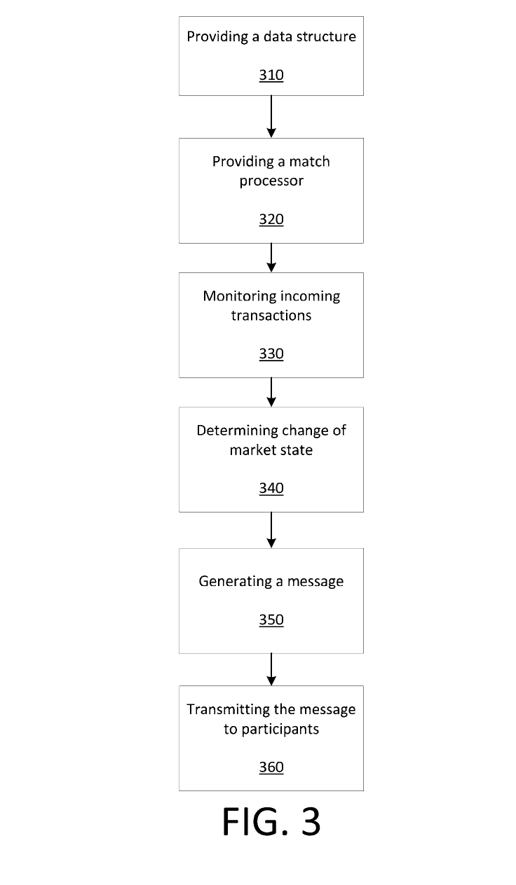

FIG. 3 depicts a flow chart showing operation of the system 200 of FIG. 2. In particular, FIG. 3 shows a computer implemented method for providing alerts to at least a subset of a plurality of participants via a network. At act 310, a data structure stored in a memory and configured to store data indicative of one or more previously received but unsatisfied transactions is provided. At act 320, a match processor coupled with the memory and operative, upon receipt of an incoming transaction, to determine whether one or more previously received but unsatisfied transactions are stored in the data structure which are at least partially counter to the incoming transaction, and, based thereon, store any residual unsatisfied portion of the incoming order or the one or more previously received but unsatisfied orders in the data structure is provided. At act 330, a monitoring processor coupled with the match processor and the memory monitors incoming transactions received by the match processor. At act 340, the monitoring processor determines when an incoming transaction for a monitored product is indicative of a change in the state of a market for the monitored product. At act 350, the monitoring processor generates a message when it is determined that the incoming transaction for the monitored product changed the state of the market for the monitored product. At act 360, the monitoring processor transmits the generated message to the subset of the plurality of participants.

In one or more embodiments, the monitoring processor generates a message when an incoming transaction satisfies a predetermined monitoring criteria or changes the status of the monitored product.

In one or more embodiments, the message is an instant message or an instant message in a chat room. In one or more embodiments, generating the message converts the transaction into the instant message.

In one or more embodiments, the changed state of the market for the monitored product is a transaction for the monitored product or an initial transaction for the monitored product

In one or more embodiments, the changed state of the market for the monitored product is a satisfied transaction for the monitored product or an initial satisfied transaction for the monitored product.

In one or more embodiments, the changed state of the market for the monitored product is one of a plurality of transactions for the monitored product, wherein the total number of transactions in the plurality of transactions is below a threshold number of transactions (e.g., any transaction under five (5) total transactions, etc.).

In one or more embodiments, the changed state of the market for the monitored product is an increase in the product quantity in the unsatisfied transactions increases over a threshold product quantity (e.g., over ten (10) total contracts) or an increase in the product quantity in the unsatisfied transactions increases by a threshold product quantity (e.g., an increase by ten (10) contracts, etc.).

In one or more embodiments, the changed state of the market for the monitored product is an increase in the number of transactions over a threshold number of transactions (e.g., over five (5) total transactions, etc.) or an increase in the number of transactions by a threshold number of transactions (e.g., an increase by five (5) total transactions, etc.).

In one or more embodiments, the changed state of the market for the monitored product occurs when the difference between a transaction to buy a product and a transaction to sell a product is less than a threshold amount (e.g., less than five ($5) dollars, etc.).

In one or more embodiments, the changed state of the market for the monitored product occurs when the incoming transaction changes the price of a product by less than a threshold amount (e.g., by less than five ($5) dollars, etc.) or when the incoming transaction changes the price of a product by more than a threshold amount (e.g., by more than five ($5) dollars, etc.).

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is therefore intended that the foregoing detailed description be regarded as illustrative rather than limiting, and that it be understood that it is the following claims, including all equivalents, that are intended to define the spirit and scope of this invention.

What is claimed is:

1. A computer implemented method for providing alerts to at least a subset of a plurality of participants via a network, the method comprising:
providing a data structure stored in a memory and configured to store data indicative of one or more previously received but unsatisfied transactions;
providing a match processor coupled with the memory and operative, upon receipt of an incoming transaction, to determine whether one or more previously received but unsatisfied transactions are stored in the data structure which are at least partially counter to the incoming transaction, and, based thereon, store any residual unsatisfied portion of the incoming order or the one or more previously received but unsatisfied orders in the data structure;
monitoring, by a monitoring processor coupled with the match processor and the memory, incoming transactions received by the match processor;
determining, by the monitoring processor, when an incoming transaction for a monitored product is indicative of a change in the state of a market for the monitored product;
generating, by the monitoring processor, when it is determined that the incoming transaction for the monitored product changed the state of the market for the monitored product, a message indicative thereof; and
transmitting, by the monitoring processor, the generated message to the subset of the plurality of participants.

2. The computer implemented method of claim 1 wherein the message is an instant message.

3. The computer implemented method of claim 2 wherein the instant message is an instant message in a chat room.

4. The computer implemented method of claim 1 wherein the changed state of the market for the monitored product is a transaction for the monitored product.

5. The computer implemented method of claim 4 wherein generating the message converts the transaction into the instant message.

6. The computer implemented method of claim 4 wherein the changed state of the market for the monitored product is an initial transaction for the monitored product.

7. The computer implemented method of claim 4 wherein the changed state of the market for the monitored product is a satisfied transaction for the monitored product.

8. The computer implemented method of claim 7 wherein the changed state of the market for the monitored product is an initial satisfied transaction for the monitored product.

9. The computer implemented method of claim 4 wherein the changed state of the market for the monitored product is one of a plurality of transactions for the monitored product, wherein the total number of transactions in the plurality of transactions is below a threshold number of transactions.

10. The computer implemented method of claim 1 wherein the changed state of the market for the monitored product is an increase in the product quantity in the unsatisfied transactions increases over a threshold product quantity.

11. The computer implemented method of claim 1 wherein the changed state of the market for the monitored product is an increase in the product quantity in the unsatisfied transactions increases by a threshold product quantity.

12. The computer implemented method of claim 1 wherein the changed state of the market for the monitored product is an increase in the number of transactions over a threshold number of transactions.

13. The computer implemented method of claim 1 wherein the changed state of the market for the monitored product is an increase in the number of transactions by a threshold number of transactions.

14. The computer implemented method of claim 1 wherein the changed state of the market for the monitored product occurs when the difference between a transaction to buy a product and a transaction to sell a product is less than a threshold amount.

15. The computer implemented method of claim 1 wherein the changed state of the market for the monitored product occurs when the incoming transaction changes the price of a product by less than a threshold amount.

16. The computer implemented method of claim 1 wherein the changed state of the market for the monitored product occurs when the incoming transaction changes the price of a product by more than a threshold amount.

17. A system for providing alerts to at least a subset of a plurality of participants via a network, the system comprising:
first logic stored in a memory to provide a data structure to store one or more previously received but unsatisfied transactions;
second logic stored in the memory and executable by the processor to cause the processor to, upon receipt of an incoming transaction, determine whether one or more previously received but unsatisfied transactions are stored in the data structure which are at least partially counter to the incoming transaction, and, based thereon, store any residual unsatisfied portion of the incoming order or the one or more previously received but unsatisfied orders in the data structure;
third logic stored in the memory and executable by the processor to cause the processor to monitor incoming transactions received and stored in the data structure;
fourth logic stored in the memory and executable by the processor to determine when an incoming transaction for a monitored product is indicative of a change in the state of a market for the monitored product;
fifth logic stored in the memory and executable by the processor to generate, when it is determined that the incoming transaction for the monitored product changed the state of the market for the monitored product, a message;
sixth logic stored in the memory and executable by the processor to transmit the generated message to the subset of the plurality of participants.

18. The system of claim 17 wherein the message is an instant message in a chat room.

19. A system for providing alerts to at least a subset of a plurality of participants via a network, the system comprising:
a data structure stored in a memory and configured to store one or more previously received but unsatisfied transactions;
a match processor coupled with the memory and operative, upon receipt of an incoming transaction, to determine whether one or more previously received but unsatisfied transactions are stored in the data structure which are at least partially counter to the incoming transaction, and, based thereon, store any residual unsatisfied portion of the incoming order or the one or more previously received but unsatisfied orders in the data structure;
a monitoring processor coupled with the match processor operative to monitor incoming transactions received by the match processor;
a determining processor coupled with the monitoring processor operative to determine when an incoming transaction for a monitored product is indicative of a change in the state of a market for the monitored product;
a message generation processor coupled to the determining processor operative to generate, when it is determined that the incoming transaction for a monitored product changed the state of the market for the monitored product, a message; and
a message transmitter coupled to the message generation processor operative to transmit the generated message to the subset of the plurality of participants.

20. The system of claim 19 wherein the message is an instant message in a chat room.
